(19) United States
(12) Patent Application Publication
(10) Pub. No.: US 2008/0298841 A1
(43) Pub. Date: Dec. 4, 2008

(54) PHOTOSENSITIVE-MEMBER DRIVING MECHANISM

(76) Inventors: Norio TOMITA, Nara (JP); Yoshikazu Harada, Nara (JP); Tetsushi Ito, Nara (JP); Tetsuya Yamaguchi, Nara (JP); Yoshiteru Kikuchi, Nara (JP); Kenichi Isomi, Nara (JP); Showtaro Okamoto, Nara (JP)

Correspondence Address: MARK D. SARALINO ( SHARP );RENNER, OTTO, BOISSELLE & SKLAR, LLP, 1621 EUCLID AVENUE, 19TH FLOOR, CLEVELAND, OH, 44115, US

(21) Appl. No.: 12/127,090

(22) Filed: May 27, 2008

(30) Foreign Application Priority Data
Jun. 1, 2007 (JP) 2007-147130
Nov. 9, 2007 (JP) 2007-292258

(51) Int. Cl. G03G 15/00

(52) U.S. Cl. 399/167

(57) ABSTRACT

It is an object to prevent distortions and deviations of images caused by the eccentricity of a driven gear mounted to a rotational shaft of a photosensitive drum. There are provided a driving gear which is secured to a rotational shaft of a rotational driving power source and is rotated at a constant peripheral speed, a driven gear secured coaxially to a rotational shaft of a cylindrical-shaped photosensitive member, a phase control gear having the same diameter as that of the driven gear and having the same rotational speed variation characteristic as that of the driven gear, and a transmission gear, and a driving force from the driving gear is transmitted to the driven gear through the phase control gear and the transmission gear.

### CROSS-REFERENCE TO RELATED APPLICATION

This application is related to Japanese Patent Applications No. 2007-147130 filed on Jun. 1, 2007 and No. 2007-292258 filed on Nov. 9, 2007, on the basis of which priorities are claimed under 35 USC §119, the disclosure of these applications being incorporated by reference in their entirety.

### BACKGROUND OF THE INVENTION

1. Field of the Invention

The present invention mainly relates to a photosensitive-member driving mechanism employed in an image forming apparatus.

2. Description of the Related Art

As countermeasures against rotation variations (peripheral speed variations) of the photosensitive drums in conventional image forming apparatuses, there have been known first type systems for matching the phases of the rotation variations of plural photosensitive members for colored-image formation for reducing color shifts (refer to Japanese Unexamined Patent Publication No. Hei7(1995)-261499, for example) and second type systems for reducing the speed variations of photosensitive members through speed controlling of the motors for driving the photosensitive members (refer to Japanese Unexamined Patent Publication No. Hei10(1998)-78734, for example).

With the aforementioned first type systems, it is impossible to eliminate the distortions of images themselves and, even in cases of monochrome images, images formed on the photosensitive members are distorted in the direction of secondary scanning, which imposes a limit on the improvement of the image quality.

Further, in cases of image forming apparatuses including plural photosensitive members with different diameters, among color image forming apparatuses, color-shift adjustments can not be performed at all. Accordingly, in order to extend the life of the photosensitive member for black-color images and in order to increase the printing speed, if only the diameter of this photosensitive member is increased, this will make it impossible to eliminate color shifts.

With the aforementioned second type systems, there is a need for providing driving motors for controlling the speeds of the respective photosensitive drums and, further, there is a need for controlling the speeds thereof with higher accuracy, which has induced the problem of increase of the number of components of the apparatus and the necessity of complicated controlling.

### SUMMARY OF THE INVENTION

According to the present invention, there is provided a photosensitive-member driving mechanism including a driving gear which is secured to a rotational shaft of a rotational driving power source and is rotated at a constant peripheral speed, a driven gear secured coaxially to a rotational shaft of a cylindrical-shaped photosensitive member, a phase control gear having the same diameter as that of the driven gear and having the same rotational speed variation characteristic as that of the driven gear, and a transmission gear, wherein the driving gear transmits a driving force to the driven gear through the phase control gear and the transmission gear.

Since the phase control gear has the same diameter as that of the driven gear and, also, has the same rotational speed variation characteristic as that of the driven gear, the variation of the peripheral speed of the photosensitive member due to the rotational speed variation characteristic of the driven gear is cancelled by the phase control gear, which causes the photosensitive member to rotate at a constant peripheral speed, thereby causing correct images with no distortions to be formed. Accordingly, even in cases of forming color images using plural photosensitive members, it is possible to form images with no color shifts.

### BRIEF DESCRIPTION OF THE DRAWINGS

FIG. 1 is an explanation view of the structure of an image forming apparatus employing photosensitive-member driving mechanisms according to the present invention;

FIG. 2 is a side view illustrating a first example of the photosensitive-member driving mechanism according to the present invention;

FIG. 3 is a front view illustrating the first example of the photosensitive-member driving mechanism according to the present invention;

FIG. 4 is a front view illustrating an exemplary arrangement of the first example of the photosensitive-member driving mechanism according to the present invention;

FIG. 5 is a front view illustrating an exemplary arrangement of a second example of the photosensitive-member driving mechanism according to the present invention;

FIG. 6 is a front view illustrating an exemplary arrangement of the second example of the photosensitive-member driving mechanism according to the present invention;

FIG. 7 is a front view illustrating an exemplary arrangement of the second example of the photosensitive-member driving mechanism according to the present invention;

FIG. 8 is a front view illustrating an exemplary arrangement of the second example of the photosensitive-member driving mechanism according to the present invention;

FIG. 9 is an explanation view illustrating the structure and operations of a third example of the image forming apparatus according to the present invention;

FIG. 10 is an explanation view illustrating the structure and operations of the third example of the image forming apparatus according to the present invention;

FIG. 11 is an explanation view illustrating the structure and operations of the third example of the image forming apparatus according to the present invention;

FIG. 12 is an explanation view illustrating the structure and operations of the third example of the image forming apparatus according to the present invention; and

FIG. 13 is an explanation view illustrating the structure and operations of the third example of the image forming apparatus according to the present invention.

### DESCRIPTION OF THE PREFERRED EMBODIMENTS

A first photosensitive-member driving mechanism according to the present invention includes a driving gear which is secured to a rotational shaft of a rotational driving power source and is rotated at a constant peripheral speed, a driven gear secured coaxially to a rotational shaft of a cylindrical-shaped photosensitive member, a phase control gear having the same diameter as that of the driven gear and having the same rotational speed variation characteristic as that of the driven gear, and a transmission gear, wherein the driving gear transmits a driving force to the driven gear through the phase control gear and the transmission gear.

The transmission gear may be adapted to transmit a peripheral speed of the phase control gear to the driven gear such that the driven gear is rotated at a constant angular speed.

The transmission gear may be detachably supported by a rotational shaft.

In the first photosensitive-member driving mechanism according to the present invention, the driven gear and the phase control gear are eccentric gears, and the driven gear and the phase control gear are provided with indexes indicative of the same rotational phase of both the gears, near the peripheral edges thereof. Assuming that a first straight line connecting the center of the driving gear and the center of the phase control gear and a second straight line connecting the center of the phase control gear and the index on the phase control gear form an angle of θ_{A} therebetween, a third straight line connecting the center of the phase control gear and the center of the transmission gear and the first straight line form an angle of θ_{X} therebetween, and a fourth straight line connecting the center of the transmission gear and the center of the driven gear and a fifth straight line connecting the center of the driven gear and the index on the driven gear form an angle of θ_{B} therebetween, it is preferable that there is the relationship of θ_{X}=60 degrees and θ_{B}−(θ_{A}−θ_{X})=−60 degrees or θ_{X}=−60 degrees and θ_{B}−(θ_{A}−θ_{X})=60 degrees (the characters of “±” indicate a direction of rotation of the driven gear and the opposite direction of rotation of the driven gear, respectively).

The indexes may be molded integrally with the driven gear and the phase control gear.

A second photosensitive-member driving mechanism according to the present invention includes a driving gear which is secured to a rotational shaft of a rotational driving power source and is rotated at a constant peripheral speed, driven gears being secured coaxially to respective rotational shafts of plural cylindrical-shaped photosensitive members and having the same diameter and the same rotational variation characteristic, a single phase control gear having the same diameter as that of the driven gears and having the same rotational speed variation characteristic as that of the driven gears, and plural transmission gears, wherein a driving force from the driving gear is transmitted to the respective driven gears through the phase control gear and the transmission gears.

A third photosensitive-member driving mechanism according to the present invention includes a first mechanism including a first driving gear which is secured to a rotational shaft of a rotational driving power source and is rotated at a constant peripheral speed, a first driven gear secured coaxially to a rotational shaft of a cylindrical-shaped photosensitive member, a first phase control gear having the same diameter as that of the first driven gear and having the same rotational speed variation characteristic as that of the first driven gear, and a first transmission gear, the first mechanism being adapted to transmit a driving force from the first driving gear to the first driven gear through the first phase control gear and the first transmission gear. Further, the third photosensitive-member driving mechanism further includes a second driving gear which is secured to a rotational shaft of a rotational driving power source and is rotated at a constant peripheral speed, second driven gears secured coaxially to respective rotational shafts of plural cylindrical-shaped photosensitive members and having the same diameter and the same rotational variation characteristic, a single second phase control gear having the same diameter as that of the second driven gears and having the same rotational speed variation characteristic as that of the second driven gears and plural second transmission gears, the second mechanism being adapted to transmit a driving force from the second driving gear to the respective second driven gears through the second phase control gear and the second transmission gears.

A fourth photosensitive-member driving mechanism according to the present invention includes a driving gear which is secured to a rotational shaft of a rotational driving power source and is rotated at a constant peripheral speed, a driven gear secured coaxially to a rotational shaft of a cylindrical-shaped photosensitive member, and a phase control gear having the same diameter as that of the driven gear and having the same rotational speed variation characteristic as that of the driven gear, wherein a driving force from the driving gear is transmitted to the driven gear through the phase control gear.

A fifth photosensitive-member driving mechanism according to the present invention includes a driving gear which is secured to a rotational shaft of a rotational driving power source and is rotated at a constant peripheral speed, plural driven gears secured coaxially to respective rotational shafts of cylindrical-shaped photosensitive members and having the same diameter and the same rotational variation characteristic, and a single phase control gear having the same diameter as that of the driven gears and having the same rotational speed variation characteristic as that of the driven gears, wherein a driving force from the driving gear is transmitted to the respective plural driven gears through the phase control gear.

In the fourth and fifth photosensitive-member driving mechanisms according to the present invention, the driven gear(s) and the phase control gear are eccentric gears, and the driven gear(s) and the phase control gear are provided with indexes indicative of the same rotational phase of both the gears. Assuming that a first straight line connecting the center of the driving gear and the center of the phase control gear and a second straight line connecting the center of the phase control gear and the index on the phase control gear form an angle of θ_{A} therebetween, a third straight line connecting the center of the phase control gear and the center of the driven gear and the first straight line form an angle of θ_{X} therebetween, and a fourth straight line connecting the center of the driven gear and the index on the driven gear and the third straight line form an angle of θ_{B} therebetween, it is preferable that there is the relationship of θ_{X}=60 degrees and θ_{B}−(θ_{A}−θ_{X})=−60 degrees or θ_{X}=−60 degrees and θ_{B}−(θ_{A}−θ_{X})=60 degrees (the characters of “±” indicate a direction of rotation of the driven gear and the opposite direction of rotation of the driven gear, respectively).

In the fourth and fifth photosensitive-member driving mechanisms according to the present invention, the driven gear(s) can include a first and second driven gears, and there is provided a transmission gear for transmitting the driving force from the first driven gear to the second driven gear.

It is preferable that the transmission gear is a gear having the same eccentricity characteristic as that of the driven gear(s).

The rotational phase of the transmission gear can be set, such that indexes on the first driven gear and the transmission gear can be coincident with the contact point between the first driven gear and the transmission gear, and indexes on the second driven gear and the transmission gear can be coincident with the contact point between the second driven gear and the transmission gear.

Hereinafter, the present invention will be described, on the basis of embodiments illustrated in the drawings.

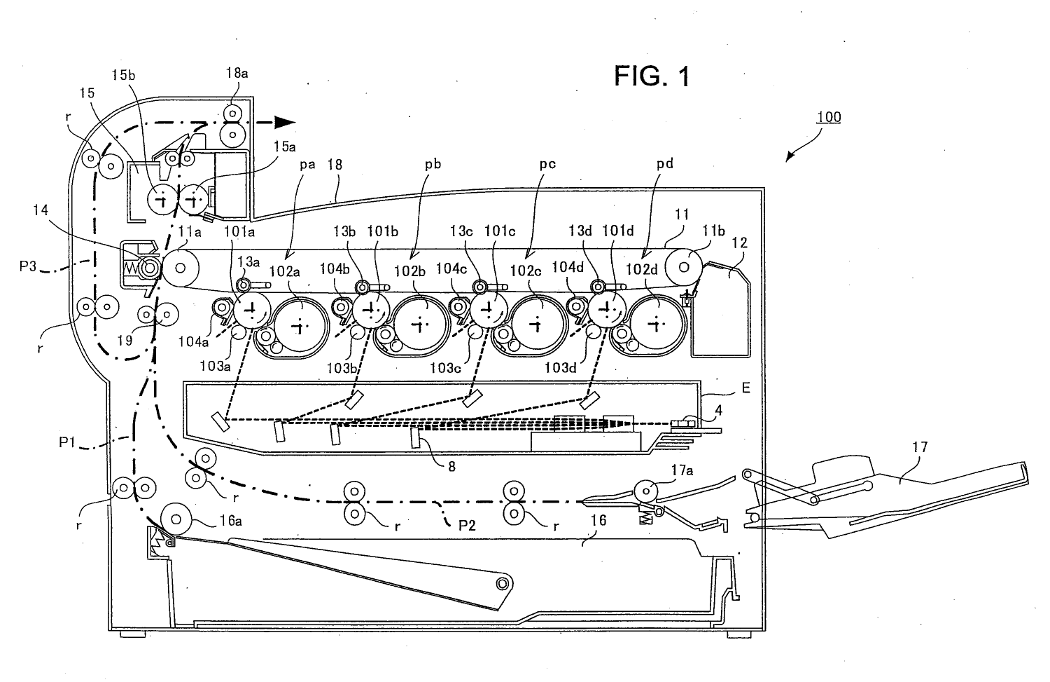

FIG. 1 is a structural explanation view illustrating the structure of an image forming apparatus employing photosensitive-member driving mechanisms according to the present invention. An image forming apparatus 100 forms multicolored images and monochrome images on recording mediums such as paper sheets, in response to image data received from the outside. Therefore, the image forming apparatus 100 includes an exposure unit E, photosensitive drums 101a to 101d with the same diameter (cylindrical-shaped photosensitive members), development units 102a to 102d, charging rollers 103a to 103d, cleaning units 104a to 104d, an intermediate transfer belt 11, intermediate transfer rollers 13a to 13d, a secondary transfer roller 14, a fixing device 15, sheet transfer paths P1, P2 and P3, a sheet feeding cassette 16, a manual sheet feeding tray 17 and a sheet ejection tray 18, and the like.

The image forming apparatus 100 forms images using image data corresponding to respective color phases, wherein the color phases correspond to four colors constituted by black (K) and three fundamental colors of cyan (C), magenta (M) and yellow (Y) according to subtractive color mixture resulted from color separation. The numbers of the photosensitive drums 101a to 101d, the development units 102a to 102d, the charging rollers 103a to 103d, the transfer rollers 13a to 13d, and the cleaning units 104a to 104d are four, in association with the respective color phases, thereby forming four image forming portions Pa to Pd. The image forming portions Pa to Pd are arranged in series in the direction of the movement of the intermediate transfer belt 11 (the direction of secondary scanning).

The charging rollers 103 are contact-type charging devices which uniformly charge the surfaces of the photosensitive drums 101 at a predetermined electric potential. The exposure unit E includes a semiconductor laser which is not illustrated, a polygon mirror 4 and a reflection mirror 8 and the like and directs respective laser beams modulated by image data corresponding to the respective color phases of black, cyan, magenta and yellow to the respective photosensitive drums 101a to 101d to form latent images corresponding to the image data on the surfaces of the photosensitive drums 101a to 101d. On the photosensitive drums 101a to 101d, latent images are formed from the image data corresponding to the respective color phases of black, cyan, magenta and yellow.

Accordingly, the photosensitive drum 101a is an image carrying member on which black toner images are formed during formation of monochrome images, while the photosensitive drum 101b to 101d are image carrying members on which toner images in three fundamental colors according to subtractive color mixture are formed during formation of full-colored images.

The development units 102a to 102d supply development agents to the surfaces of the photosensitive drums 101a to 101d on which latent images have been formed, to elicit the latent images into toner images. The respective development units 102a to 102d house the development agents corresponding to the respective color phases of black, cyan, magenta and yellow and elicit the latent images corresponding to the respective color phases formed on the photosensitive drums 101a to 101d into toner images corresponding to the respective color phases of black, cyan, magenta and yellow. The cleaning units 104a to 104d remove and collect toners residue on the surfaces of the photosensitive drums 101a to 101d after development and image transferring.

The intermediate transfer belt 11 placed above the photosensitive drums 101a to 101d is stringed between a driving roller 11a and a driven roller 11b to form a loop-shaped movement path. The outer peripheral surface of the intermediate transfer belt 11 is faced to the photosensitive drum 101d, the photosensitive drum 101c, the photosensitive drum 101b and the photosensitive drum 101a, in the mentioned order.

The transfer rollers 13a to 13d are placed at positions facing to the respective photosensitive drums 101a to 101d across the intermediate transfer belt 11. A transferring bias with the opposite polarity from the polarity of charges on the toners is applied to the transfer rollers 13a to 13d, in order to transfer the toner images carried on the surfaces of the photosensitive drums 101a to 101d to the intermediate transfer belt 11. Accordingly, the toner images corresponding to the respective color phases formed on the photosensitive drums 101a to 101d are transferred, in order, to the outer peripheral surface of the intermediate transfer belt 11 such that they are superimposed thereon, thereby causing full-colored toner images to be formed on the outer peripheral surface of the intermediate transfer belt 11.

However, in cases where image data about only some of the color phases of cyan, magenta, yellow and black is inputted, latent images and toner images are formed on only the photosensitive drums corresponding to the color phases of the inputted image data, out of the four photosensitive drums 101a to 101d. For example, during formation of monochrome images, latent images and toner images are formed only on the photosensitive drum 101a corresponding to the black color phase, and only black toner images are transferred to the outer peripheral surface of the intermediate transfer belt 11.

Each of the transfer rollers 13a to 13d is formed from a shaft made of a metal (for example, a stainless steel) with a diameter in the range of 8 to 10 mm and a conductive elastic member (for example, EPDM, foamed urethane) covering the surface of the shaft, and a high voltage is uniformly applied to the intermediate transfer belt 11 through the conductive elastic member. Instead of such transfer rollers, it is possible to employ brush-type intermediate transfer members.

The toner images formed on the outer peripheral surface of the intermediate transfer belt 11 as described above are transferred to the position faced to the secondary transfer roller 14, through the rotation of the intermediate transfer belt 11. During image formation, the secondary transfer roller 14 is kept in contact with the outer peripheral surface of the intermediate transfer belt 11 at a predetermined nipping pressure. When a paper sheet fed from the sheet cassette 16 or the manual sheet feeding tray 17 passes between the secondary transfer belt 14 and the intermediate transfer belt 11, a high voltage with the opposite polarity from the polarity of the charges on the toners is applied to the secondary transfer roller 14. Thus, the toner images are transferred to the surface of the paper sheet from the outer peripheral surface of the intermediate transfer belt 11.

Further, in order to maintain the nipping pressure between the secondary transfer roller 14 and the intermediate transfer belt 11 at a predetermined value, any one of the secondary transfer roller 14 and the driving roller 11a is formed from a hard material (such as metal), while the other one of them is formed from a soft material such as an elastic roller (for example, an elastic rubber roller or a foamed-resin roller).

Further, the toners residue on the intermediate transfer belt 11 which was not transferred to the paper sheet, out of the toners adhered to the intermediate transfer belt 11 from the photosensitive drums 101a to 101d, are collected by the cleaning units 12, in order to prevent the occurrence of color mixture in the subsequent processes.

The paper sheet to which toner images have been transferred is directed to the fixing device 15 and is passed between a heating roller 15a and a pressing roller 15b to be heated and pressed thereby. Consequently, the toner images are firmly fixed to the surface of the paper sheet. The paper sheet on which the toner images have been fixed is ejected to the sheet ejection tray 18 through a sheet ejection roller 18a.

The image forming apparatus 100 is provided with the sheet transfer path P1 substantially in the vertical direction for feeding paper sheets housed in the sheet cassette 16 to the sheet ejection tray 18 through between the secondary transfer roller 14 and the intermediate transfer belt 11 and through the fixing device 15. Along the sheet transfer path P1, there are placed a pickup roller 16a for bringing up paper sheets within the sheet cassette 16 into the sheet transfer path P1 one by one, a transfer roller r for upwardly transferring the paper sheets which have been brought up, a resist roller 19 for directing the paper sheets transferred thereto to between the secondary transfer roller 14 and the intermediate transfer belt 11 at predetermined timing, and the sheet ejection roller 18a for ejecting the paper sheets onto the sheet ejection tray 18.

Further, inside of the image forming apparatus 100, there is formed the sheet transfer path P2 along which a pickup roller 17a and the transfer roller r are placed, between the manual sheet feeding tray 17 and the resist roller 19. Further, there is formed the sheet transfer path P3, between the sheet ejection roller 18a and the side of the sheet transfer path P1 upstream from the resist roller 19.

The sheet ejection roller 18a is made rotatable in both a normal direction and the opposite direction and is driven in the direction of normal rotation to eject paper sheets onto the sheet ejection tray 18, during one-side image formation for forming images on one surfaces of paper sheets and during second-side image formation in double-side image formation for forming images on the both sides of paper sheets. On the other hand, during first-side image formation in double-side image formation, the ejection roller 18a is driven in the direction of normal rotation until the rear end of a paper sheet passes through the fixing device 15 and, thereafter, is driven in the direction of reverse rotation to direct the paper sheet to the sheet transfer path P3 while holding the rear end portion of the paper sheet. Thus, during double-side image formation, the paper sheet which has been subjected to image formation on its one side is directed to the sheet transfer path P1 at a state where its front and rear surfaces and its front and rear ends are reversed.

The resist roller 19 directs paper sheets fed from the sheet cassette 16 or the manual sheet feeding tray 17 or paper sheets transferred through the sheet transfer path P3 to between the secondary transfer roller 14 and the intermediate transfer belt 11 at timing synchronized with the rotation of the intermediate transfer belt 11. Accordingly, the resist roller 19 is stopped rotating at the start of the operations of the photosensitive drums 101 and the intermediate transfer belt 11, and a paper sheet fed or transferred prior to the rotation of the intermediate transfer belt 11 is stopped moving along the sheet transfer path P1 at a state where its front end is kept in contact with the resist roller 19. Thereafter, the resist roller 19 starts rotating at such timing that the front end portion of the paper sheet and the front end portion of the toner image formed on the intermediate transfer belt 11 are faced to each other, at the position where the secondary transfer roller 14 and the intermediate transfer belt 11 are contacted with each other in such a way as to press each other.

### FIRST EXAMPLE

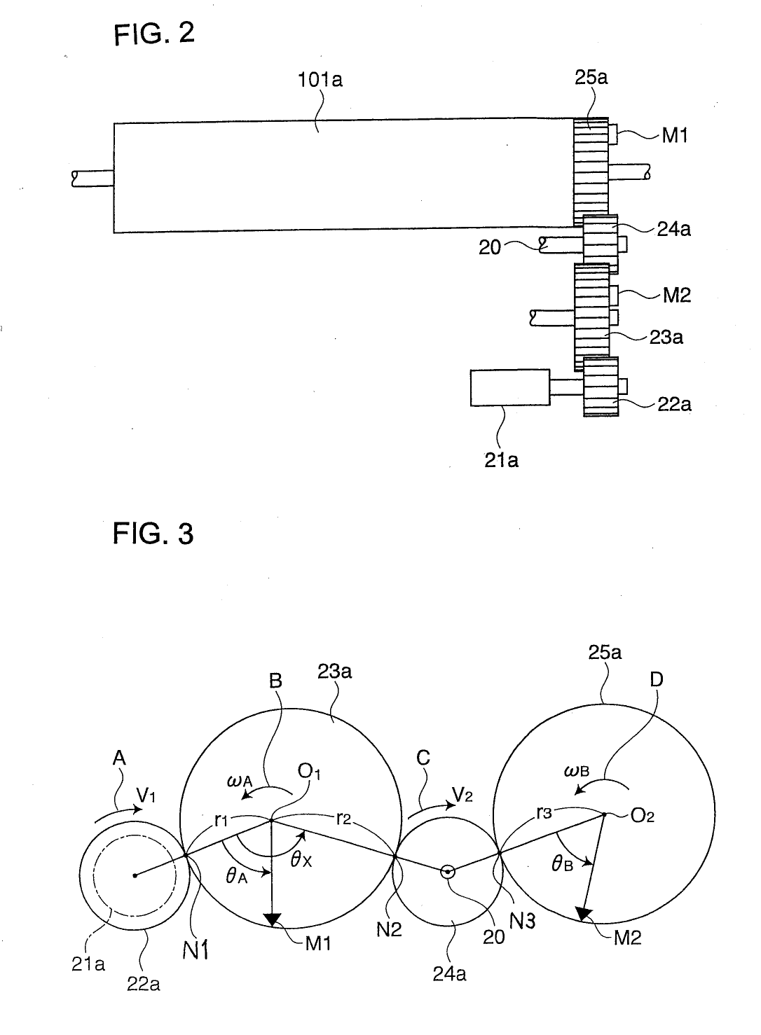

FIG. 2 is a side view illustrating a first example of a photosensitive-member driving mechanism applied to the image forming apparatus of FIG. 1, and FIG. 3 is a front view of the first example. In these figures, a driving gear 22a is driven by a motor 2 la as a rotation driving source and is rotated in the direction of an arrow A at a constant peripheral speed of VI.

A driven gear 25a is a gear which is coupled to an end portion of the photosensitive drum 101a and rotates the drum 101a in the direction of an arrow D at a photosensitive-member angular speed ω_{B}. While there will be described only the driving mechanism for the photosensitive drum 101a hereinafter, the photosensitive drums 101b to 101d illustrated in FIG. 1 also have the same driving mechanism.

A phase control gear 23a is a gear having the same speed variation characteristic as that of the driven gear 25a and is formed using the same die as that for the driven gear 25a. The speed variation characteristic is mainly caused by the eccentricity of the gear, and gears formed using the same die will have the same eccentricity characteristic.

The driving gear 22a is contacted with the phase control gear 23a and transmits a driving force thereto. The driving force from the phase control gear 23a is transmitted to the driven gear 25a through a transmission gear 24a. The phase control gear 23a is rotated in the direction of an arrow B at an angular speed of ω_{A}, and the transmission gear 24a is rotated in the direction of an arrow C at a peripheral speed of V2.

The phase control gear 23a and the driven gear 25a in FIG. 3 are provided with triangular marks M1 and M2, which are formed from protruding portions (see FIG. 2) formed during the integral formation of the respective gears and used as indexes indicative of the same rotational phase of both the gears (hereinafter, the triangular marks will be referred to as indexes).

Accordingly, the indexes M1 and M2 enable visually recognizing the rotational phase of the phase control gear 23a and the driven gear 25a. In the present invention, adjustments are performed by visually recognizing the positions of the indexes M1 and M2 during assembling of the driving mechanism. The transmission gear 24a is detachably supported by a rotational shaft 20 and, therefore, the phase control gear 23a and the driven gear 25a are manually rotated to determine their respective rotational phases at a state where the transmission gear 24a is disengaged therefrom and, thereafter, the transmission gear 24a is mounted to the rotational shaft 20.

The photosensitive-member driving mechanism according to the present invention includes the driving gear 22a which rotates at a constant peripheral speed, the driven gear 25a secured to an end portion of the photosensitive drum 101a, the phase control gear 23a having the same speed variation characteristic as that of the driven gear 25a, and the transmission gear 24a which transmits the rotation of the phase control gear 23a to the driven gear 25a such that the driven gear 25a is rotated at a constant angular speed. With this structure, it is possible to maintain, finally, the peripheral speed of the photosensitive drum 101a at a constant speed to reduce the deviation of the laser writing position with respect to the photosensitive drum 101a and the deviation of the transferring position at which toner images are transferred from the photosensitive drum 101a to the intermediate transfer belt 11 (FIG. 1), thereby finally reducing the deviation of the image forming position.

There will be further described the structure and the functions of the photosensitive-member driving mechanisms according to the present invention.

As illustrated in FIG. 3, it is assumed that the peripheral speed of the driving gear 22a is V1, the radius from the contact point N1 between the phase control gear 23a and the driving gear 22a to the rotational center 0₁ is r₁, the radius from the contact point N2 between the phase control gear 23a and the transmission gear 24a to the rotational center 0₁ is r₂, and the radius from the contact point N3 between the driven gear 25a and the transmission gear 24a to the rotational center 0₂ is r₃.

Further, it is assumed that the angular speeds of the phase control gear 23a and the driven gear 25a are ω_{A} and ω_{B}, respectively, the straight line connecting the center 0₁ and the point N1 and the straight line connecting the center 0₁ and the index M1 form an angle of θ_{A} therebetween, the straight line connecting the center 0₁ and the point N1 and the straight line connecting the center 0₁ and the point N2 form an angle of θ_{X} therebetween, and the straight line connecting the center 0₂ and the point N3 and the straight line connecting the center 0₂ and the index M2 form an angle of θ_{B} therebetween.

v1 is the peripheral speed of the driving motor, which is constant. Further, assuming that r is the designed radius of the phase control gear 23a and the driven gear 25a, r1, r2 and r3 are periodically-varying values as will be described later, due to the eccentricities of the phase control gear 23a and the driven gear 25a.

r1=r+ra sin θ_{A}, r2=r+ra sin(θ_{A}−θ_{X}), r3=r+ra sin θ_{B}

In this case, a is the ratio of the varying portion of r1, r2 and r3 caused by the periodic variation thereof relative to r.

Therefore, the angular speed θ_{A} of the phase control gear 23a is expressed as follows.

ω_{A}=v₁/r₁=v₁/(r+ra sin θ_{A})=(v₁/r)/(1+a sin θ_{A})=(v₁/r)·(1−a sin θ_{A})/(1−a² sin θ_{A})

Since the inequality a<<1 holds, the equation a²=0 holds.

Accordingly, the following equation holds.

ω_{A}=(v₁/r)(1−a sin θ_{A}) (1)

Next, the peripheral speed v₂ of the transmission gear 24a is expressed as follows.

v₂=r₂ω_{A}=v₁{1−a sin θ_{A}+a sin(θ_{A}−θ_{X})} (2)

Next, the angular speed ω_{B} of the driven gear 25a is expressed as follows.

ω_{B}=v₂/r₃=(v₁/r){1−a sin θ_{A}+a sin(θ_{A}−θ_{X})−a sin θ_{B}} (3)

From the above description, the varying portions Δω_{A} and Δω_{B} of the angular speeds ω_{A} and ω_{B} are expressed as follows.

Δω_{A}=−a sin θ_{A}

Δω_{B}=−a sin θ_{A}+a sin(θ_{A}−θ_{X})−a sin θ_{B}

Hereinafter, the condition for satisfying the relationship of Δω_{B}=0 will be determined. This condition is a condition which can make the variation of the angular speed ω_{B} of the driven gear 25a to be zero, thereby making the variation of the peripheral speed of the photosensitive drum 101a to be zero.

In order to satisfy the relationship of Δω_{B}=0, “X” satisfying such a condition of θ_{X}, θ_{A} and θ_{B} as to cause the equation (3) to satisfy the following equation (4) is determined, and the condition for satisfying the relationship of X=0 is determined.

θ_{B}=(v₁/r){1−X sin θ_{B}} (4)

At first, it has been proven that, in the case where the following equation (5) holds, the equation (4) can be satisfied.

θ_{X}=2θ_{A}−2θ_{B}−180 (5)

Therefore, the equation (5) is substituted into the equation (3) to provide the following equation.

$$\begin{matrix}{ω}_{B} = ( {v}_{1} / r ) \cdot [ 1 - a sin {θ}_{A} + \\ a sin \{ {θ}_{A} - ( 2 {θ}_{A} - 2 {θ}_{B} - 180 ) \} - a sin {θ}_{B} ] \\ = ( {v}_{1} / r ) \cdot [ 1 - \{ a + 2 a cos ( {θ}_{A} - {θ}_{B} ) \} sin {θ}_{B} ] \\ = ( {v}_{1} / r ) \cdot [ 1 - \{ a + 2 a cos ( {θ}_{X} - ( {θ}_{B} - ( {θ}_{A} - {θ}_{X} ) ) ) \} sin {θ}_{B} ]\end{matrix} \qquad ( 6 )$$

In the equation (6), θ_{B}−(θ_{A}−θ_{X}) means the value of θ_{B} in the case of θ_{A}=θ_{X}, namely the positional relationship between the phase control gear 23 and the driven gear 25.

Accordingly, the condition which can satisfy the equation X=0 is as follows.

X=a+2a cos(θ_{X}−(θ_{B}−(θ_{A}−θ_{X})))=0

Namely, when the equation of cos(θ_{X}−(θ_{B}−(θ_{A}−θ_{X})))=−0.5 holds, the equation X=0 holds.

The conditions of θ_{X}, θ_{A}, and θ_{B} which satisfy the aforementioned equation are expressed as follows.

θ_{X}−(θ_{B}−(θ_{A}−θ_{X}))=±120° (7)

and

θ_{X}=2θ_{A}−2θ_{B}180° (5)

The concrete numerical values which satisfy the equation (7) and the aforementioned equation (5) are as follows.

θ_{X}=60°, and θ_{B}−(θ_{A}−θ_{X})=−60°

or

θ_{X}=−60°, and θ_{B}−(θ_{A}−θ_{X})=60°

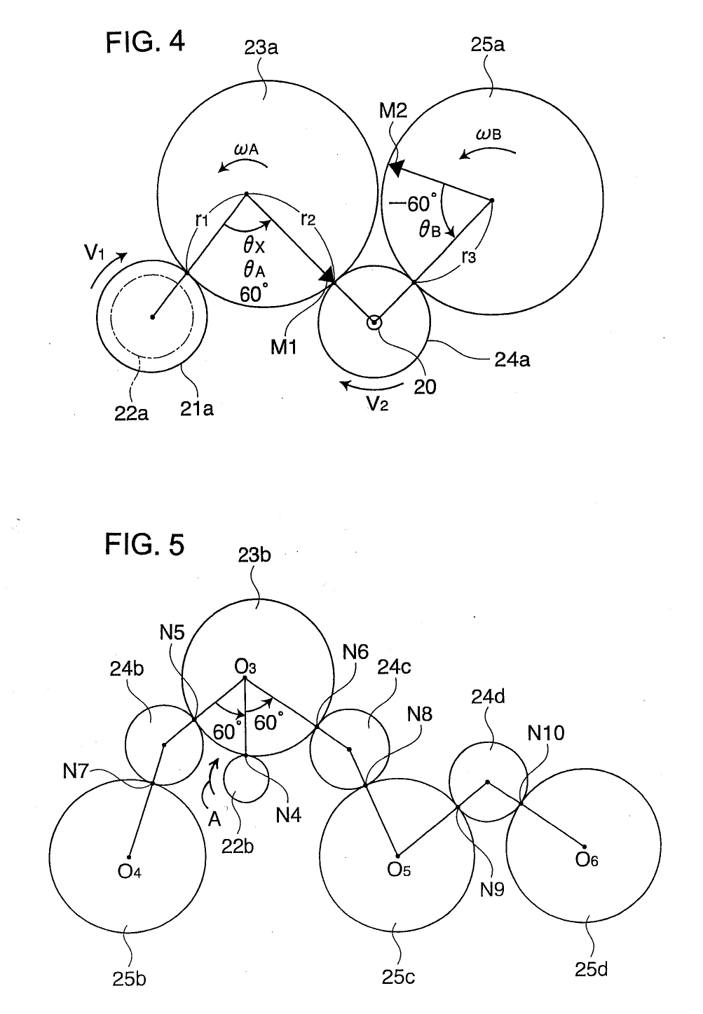

FIG. 4 illustrates a concrete example of the photosensitive-member driving mechanism in the case of θ_{X}=60° and θ_{B}−(θ_{A}−θ_{X})=−60° and θ_{X}=θ_{A}, which is one of the conditions which satisfy the equation Δω_{B}=0.

As illustrated in FIG. 4, by setting the positions of the indexes M1 and M2 on the respective gears, it is possible to make the varying portion Δω_{B} of the angular speed of the driven gear 25a to be zero, thereby rotating the photosensitive drum 101a at a constant angular speed (at a constant peripheral speed).

### SECOND EXAMPLE

In the present example, there will be described the photosensitive-member driving mechanisms which are integrally applied to the photosensitive drums 101b to 101d for forming full-colored images in the image forming apparatus 100 illustrated in FIG. 1.

Further, the photosensitive-member driving mechanism according to the first example is applied to the photosensitive drum 101a for forming black-colored images. In this case, the photosensitive drum 101a can have a diameter larger than that of the other photosensitive drums 101b to 101d.

FIGS. 5 to 8 illustrate the positional and angular relationship among the respective components of the photosensitive-member driving mechanisms according to the present example.

As illustrated in FIG. 5, the rotational force from a driving gear 22b which is driven at a constant speed in the direction of an arrow A by a motor, not illustrated, is transmitted to a phase control gear 23b and, then, the rotational force is transmitted from the phase control gear 23b to a driven gear 25b through a transmission gear 24b, also is transmitted to a driven gear 25c through a transmission gear 24c and, then, is transmitted from the driven gear 25c to a driven gear 25d through a transmission gear 24d. The driven gears 25b to 25d are coupled to end portions of the photosensitive drums 101b to 101d, respectively. Further, the driven gears 25b to 25d and the phase control gear 23b are formed using the same die and have the same speed variation characteristic.

Further, the phase control gear 23b has a rotational center 0₃ and is contacted with the driving gear 22b and the transmission gears 24b and 24c at points N4, N5 and N6, respectively, while the driven gear 25b has a rotational center 0₄ and is contacted with the transmission gear 24b at a point N7. The driven gear 25c has a rotational center 0₅ and is contacted with the transmission gears 24c and 24d at points N8 and N9. The driven gear 25d has a rotational center 0₆ and is contacted with the transmission gear 24d at a point N10.

Further, as illustrated in FIG. 5, similarly to the example illustrated in FIG. 4, the straight line connecting the rotational center 0₃ of the phase control gear 23b and the point N4 and the straight line connecting the rotational center 0₃ thereof and the point N5 form an angle of 60° therebetween. Further, the straight line connecting the rotational center 0₃ and the point N4 and the straight line connecting the rotational center 0₃ and the point N6 form an angle of 60° therebetween.

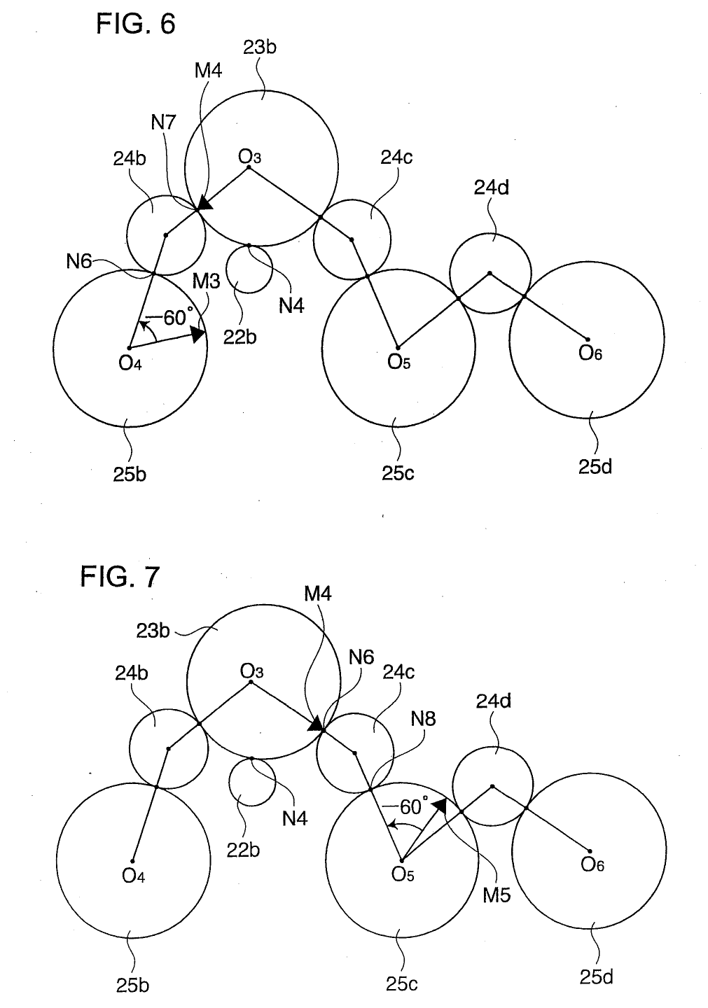

Next, regarding the driven gear 25b, as illustrated in FIG. 6, when an index M4 on the phase control gear 23b is coincident with the point N7, the straight line connecting the rotational center 0₄ of the driven gear 25b and the point N6 and the straight line connecting the rotational center 0₄ and an index M3 form an angle of −60° therebetween.

Next, regarding the driven gear 25c, as illustrated in FIG. 7, when the index M4 on the phase control gear 23b is coincident with the point N6, the straight line connecting the rotational center 0₅ of the driven gear 25c and the point N8 and the straight line connecting the rotational center 0₅ and an index M5 form an angle of −60° therebetween.

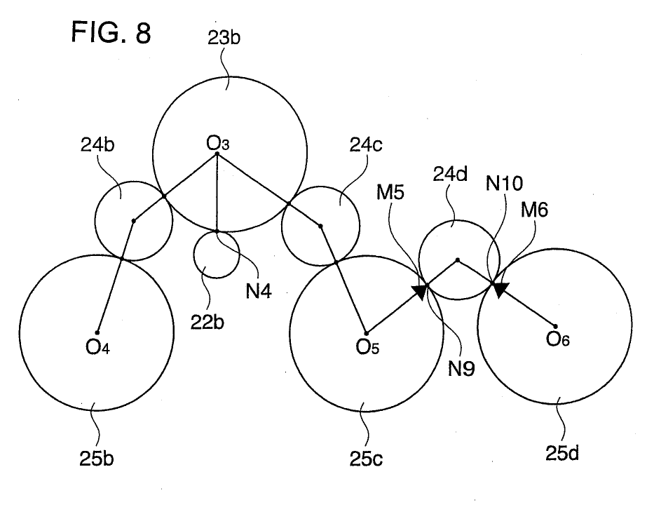

Next, regarding the driven gear 25d, as illustrated in FIG. 8, an index M6 is set, thereon, to be coincident with the point N10, when the index MS on the driven gear 25c is coincident with the point N9.

By setting as described above, a state of θ_{B}−(θ_{A}−θ_{X})=0° is realized. In this case, the following condition is satisfied. Since the variation of the angular speed of the driven gear 25c is 0, the variation of the angular speed of the driven gear 25d can be made zero.

θ_{B}−(θ_{A}−θ_{X})=0, namely θ_{B}=θ_{A}−θ_{X}

Accordingly, the following equation holds.

$$\begin{matrix}{ω}_{B} = ( {v}_{1} / r ) \cdot \{ 1 - a sin {θ}_{A} + a sin ( {θ}_{A} - {θ}_{X} ) - a sin {θ}_{B} \} \\ = ( {v}_{1} / r ) \cdot ( 1 - a sin {θ}_{A} ) \\ = {ω}_{A}\end{matrix}$$

Namely, since ω_{B} equals to ω_{A}, if the angular speed variation Δω_{A} is 0, Δω_{B} is also zero.

As described above, it is possible to rotate the photosensitive drums 101a, 101b, 101c and 101d at constant angular speeds which are not varied, similarly, in the second example.

### THIRD EXAMPLE

In the present example, there will be described the photosensitive-member driving mechanisms which are integrally applied to the photosensitive drums 101b to 101d for forming full-colored images in the image forming apparatus 100 illustrated in FIG. 1.

Further, the photosensitive-member driving mechanism according to the first example is applied to the photosensitive drum 101a for forming black-colored images. In this case, the photosensitive drum 101a can have a diameter larger than that of the other photosensitive drums 101b to 101d.

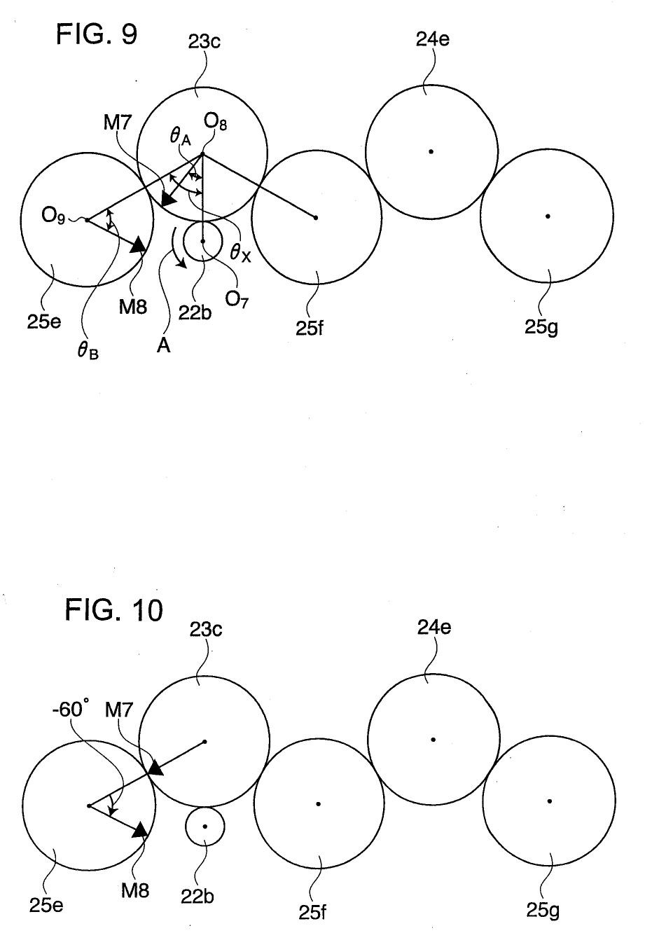

FIGS. 9 to 13 illustrate the positional and angular relationship among the respective components of the photosensitive-member driving mechanisms according to the present example 3.

As illustrated in FIG. 9, a rotational force from the driving gear 22b which is driven at a constant speed in the direction of an arrow A by a motor, not illustrated, is transmitted to a phase control gear 23c, and the driving force is transmitted from the phase control gear 23c to a driven gear 25e and also is transmitted from the phase control gear 23c to a driven gear 25f, and then is transmitted from the driven gear 25f to a driven gear 25g through a transmission gear 24e. The driven gears 25e to 25g are coupled to end portions of the photosensitive drums 101b to 101d (FIG. 1), respectively. Further, the driven gears 25e to 25g, the phase control gear 23c and the transmission gear 24e are formed using the same die and have the same speed variation characteristic.

With reference to FIG. 9, the operations of the photosensitive-member driving mechanisms will be described, with respect to the relationship between the phase control gear 23c and the driven gear 25e which is representative thereof.

The following angles are set;

the angle θ_{A} between a first straight line connecting the center 0₇ of the driving gear and the center 0₈ of the phase control gear and a second straight line connecting the center 0₈ of the phase control gear 23c and an index M7 on the phase control gear 23c,
the angle θ_{B} between a third straight line connecting the center 0₈ of the phase control gear 23c and the center 0₉ of the driven gear 25e and a fourth straight line connecting the center 0₉ of the driven gear 25e and an index M8 on the driven gear 25e, and
the angle θ_{X} between the first straight line and the third straight line.

Further, in the case where there is the relationship θ_{X}=60° and θ_{B}−(θ_{A}−θ_{X})=−60° or θ_{X}=−60° and θ_{B}−(θ_{A}−θ_{X})=60° (the characters of “+” and “−” indicate a direction of rotation of the driven gear 25e and the opposite direction of rotation of the driven gear 25e, respectively), the angular speed variation of the driven gear 25e can be made zero.

FIG. 10 concretely illustrates the condition on the phases of the phase control gear 23c and the driven gear 25e.

The index M7 on the phase control gear 23c is rotated from the contact point between the phase control gear 23c and the driven gear 22b by 60 degrees in the direction of the rotation of the phase control gear 23c to cause the index M7 on the phase control gear 23c to be coincident with the contact point between the phase control gear 23c and the driven gear 25e (θ_{X}=60°) and, also, the index M8 on the driven gear 25e is rotated by 60° in the opposite direction of the rotation of the driven gear 25e (−60°).

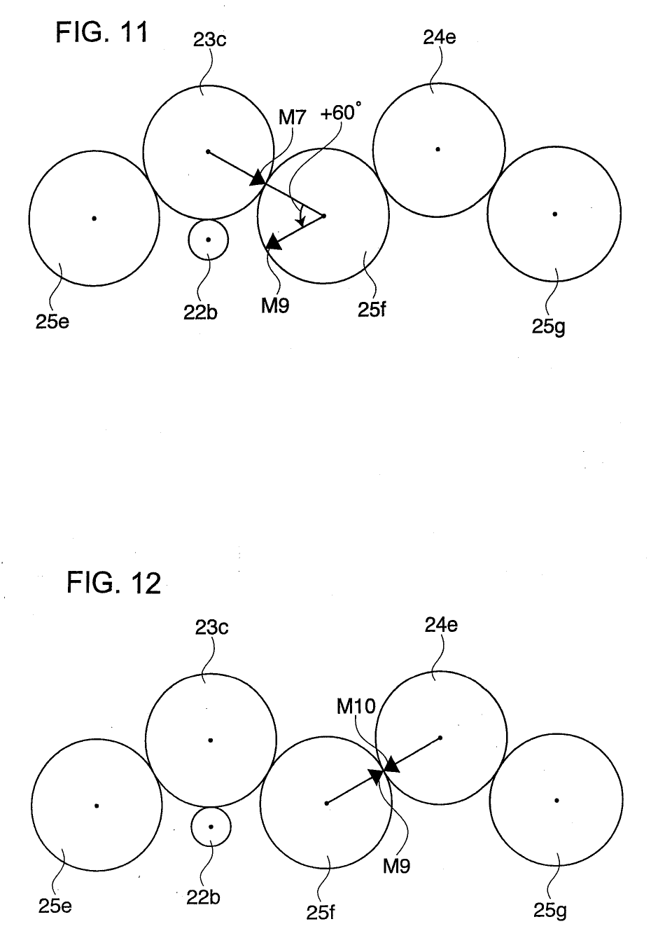

FIG. 11 concretely illustrates the condition on the phases of the phase control gear 23c and the driven gear 25f.

The index M7 on the phase control gear 23c is rotated from the contact point between the phase control gear 23c and the driven gear 22b by 60° in the opposite direction of the rotation of the phase control gear 23c (θ_{X}=−60°) to cause the index M7 to be coincident with the contact point between the phase control gear 23c and the driven gear 25f and, also, an index M9 on the driven gear 25f is rotated by 60° in the direction of the rotation of the driven gear 25f (+60°).

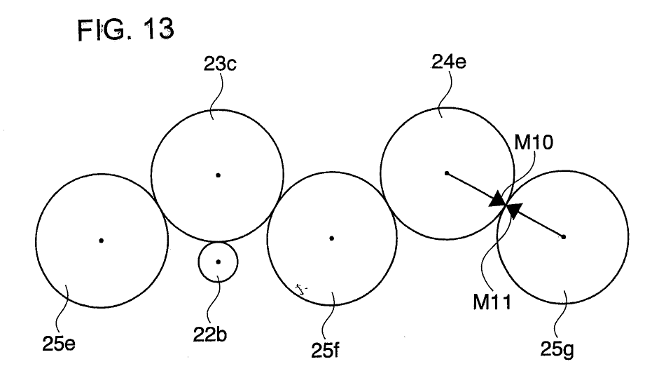

FIG. 12 and FIG. 13 illustrate the driving of the transmission gear 24e by the driven gear 25f and the driving of the driven gear 25g.

FIG. 12 illustrates the condition on driving the transmission gear 24e by the driven gear 25f.

At first, the driven gear 25f and the transmission gear 24e are set, such that an index M10 on the transmission gear 24e is coincident with the contact point between the transmission gear 24e and the driven gear 25f, when the index M9 on the driven gear 25f is coincident with the contact point between the driven gear 25f and the transmission gear 24e.

By setting as described above, a state of θ_{B}−(θ_{A}−θ_{X})=0 is realized, between the driven gear 25f and the transmission gear 24e. In this case, the condition of the following equation (8) is satisfied, since the driven gear 25f and the transmission gear 24e have the same eccentricity characteristic. Since the angular speed variation (Δω_{A}) of the driven gear 25f is zero, the angular speed variation (Δω_{B}) of the transmission gear 24e can be made zero.

θ_{B}−(θ_{A}−θ_{X})=0, namely θ_{B}=θ_{A}−θ_{X}

Accordingly, the following equation holds.

$$\begin{matrix}{ω}_{B} = ( {v}_{1} / r ) \cdot \{ 1 - a sin {θ}_{A} + a sin ( {θ}_{A} - {θ}_{X} ) - a sin {θ}_{B} \} \\ = ( {v}_{1} / r ) \cdot ( 1 - a sin {θ}_{A} ) \\ = {ω}_{A}\end{matrix} \qquad ( 8 )$$

Namely, ω_{B} equals to ω_{A} and, therefore, if the angular speed variation Δω_{A} is zero, then Δω_{B} is zero.

Next, FIG. 13 illustrates the condition on driving of the driven gear 25g by the transmission gear 24e.

At first, the driven gear 25g and the transmission gear 24e are set, such that the index M10 on the transmission gear 24e is coincident with the contact point between the transmission gear 24e and the driven gear 25g, when the index M11 on the driven gear 25g is coincident with the contact point between the driven gear 25g and the transmission gear 24e.

By setting as described above, a state of θ_{B}−(θ_{A}−θ_{X})=0° is realized, between the driven gear 25g and the transmission gear 24e. In this case, the aforementioned equation (8) holds. Since the angular speed variation (Δω_{A}) of the transmission gear is zero, the angular speed variation (Δω_{B}) of the driven gear 25g can be made zero.

By doing as described above, it is possible to rotate the photosensitive drums 101b to 101d at constant rotation speeds which are not varied.

What is claimed is:

1. A photosensitive-member driving mechanism comprising:
a driving gear which is secured to a rotational shaft of a rotational driving power source and is rotated at a constant peripheral speed;
a driven gear secured coaxially to a rotational shaft of a cylindrical-shaped photosensitive member;
a phase control gear having the same diameter as that of the driven gear and having the same rotational speed variation characteristic as that of the driven gear; and
a transmission gear,
wherein the driving gear transmits a driving force to the driven gear through the phase control gear and the transmission gear.

2. The photosensitive-member driving mechanism according to claim 1, wherein the transmission gear is adapted to transmit a peripheral speed of the phase control gear to the driven gear such that the driven gear is rotated at a constant angular speed.

3. The photosensitive-member driving mechanism according to claim 1, wherein the transmission gear is detachably supported by a rotational shaft.

4. The photosensitive-member driving mechanism according to claim 1, wherein θ_{X}=60° and θ_{B}−(θ_{A}−θ_{X}) −60° or θ_{X}=−60° and θ_{B}−(θ_{A}−θ_{X})=60° (the characters of “+” and “−” indicate a direction of rotation of the driven gear and the opposite direction of rotation of the driven gear, respectively), when the driven gear and the phase control gear are eccentric gears, and the driven gear and the phase control gear are provided with indexes indicative of the same rotational phase of both the gears,
a first straight line connecting the center of the driving gear and the center of the phase control gear and a second straight line connecting the center of the phase control gear and the index on the phase control gear forming an angle of θ_{A} therebetween,
a third straight line connecting the center of the phase control gear and the center of the transmission gear and the first straight line forming an angle of θ_{X} therebetween,
a fourth straight line connecting the center of the transmission gear and the center of the driven gear and a fifth straight line connecting the center of the driven gear and the index on the driven gear forming an angle of θ_{B} therebetween.

5. The photosensitive-member driving mechanism according to claim 4, wherein the indexes are molded integrally with the driven gear and the phase control gear.

6. A photosensitive-member driving mechanism comprising:
a driving gear which is secured to a rotational shaft of a rotational driving power source and is rotated at a constant peripheral speed;
driven gears being secured coaxially to respective rotational shafts of plural cylindrical-shaped photosensitive members and having the same diameter and the same rotational variation characteristic;
a single phase control gear having the same diameter as that of the driven gears and having the same rotational speed variation characteristic as that of the driven gears; and
plural transmission gears,
wherein the driving gear transmits a driving force to the respective driven gears through the phase control gear and the transmission gears.

7. A photosensitive-member driving mechanism comprising:
a first mechanism comprising a first driving gear which is secured to a rotational shaft of a rotational driving power source and is rotated at a constant peripheral speed, a first driven gear secured coaxially to a rotational shaft of a cylindrical-shaped photosensitive member, a first phase control gear having the same diameter as that of the first driven gear and having the same rotational speed variation characteristic as that of the first driven gear, and a first transmission gear, the first mechanism being adapted to transmit a driving force from the first driving gear to the first driven gear through the first phase control gear and the first transmission gear; and
a second mechanism comprising a second driving gear which is secured to a rotational shaft of a rotational driving power source and is rotated at a constant peripheral speed, second driven gears secured coaxially to respective rotational shafts of plural cylindrical-shaped photosensitive members and having the same diameter and the same rotational variation characteristic, a single second phase control gear having the same diameter as that of the second driven gears and having the same rotational speed variation characteristic as that of the second driven gears, and plural second transmission gears, the second mechanism being adapted to transmit a driving force from the second driving gear to the respective second driven gears through the second phase control gear and the second transmission gears.

8. A photosensitive-member driving mechanism comprising;
a driving gear which is secured to a rotational shaft of a rotational driving power source and is rotated at a constant peripheral speed,
a driven gear secured coaxially to a rotational shaft of a cylindrical-shaped photosensitive member; and
a phase control gear having the same diameter as that of the driven gear and having the same rotational speed variation characteristic as that of the driven gear,
wherein the driving gear transmits a driving force to the driven gear through the phase control gear.

9. A photosensitive-member driving mechanism comprising;
a driving gear which is secured to a rotational shaft of a rotational driving power source and is rotated at a constant peripheral speed;
a plurality of driven gears secured coaxially to respective rotational shafts of cylindrical-shaped photosensitive members and having the same diameter and the same rotational variation characteristic; and
a single phase control gear having the same diameter as that of the driven gears and having the same rotational speed variation characteristic as that of the driven gears,
wherein the driving gear transmits a driving force to the respective plural driven gears through the phase control gear.

10. The photosensitive-member driving mechanism according to claim 8, wherein θ_{X}=60° and θ_{B}−(θ_{A}−θ_{X})=−60° or θ_{X}=−60° and θ_{B}−(θ_{A}−θ_{X})=60° (the characters of “+” and “−” indicate a direction of rotation of the driven gear and the opposite direction of rotation of the driven gear, respectively), when the driven gear and the phase control gear are eccentric gears, and the driven gear and the phase control gear are provided with indexes indicative of the same rotational phase of both the gears,
a first straight line connecting the center of the driving gear and the center of the phase control gear and a second straight line connecting the center of the phase control gear and the index on the phase control gear forming an angle of θ_{A} therebetween,
a third straight line connecting the center of the phase control gear and the center of the driven gear and the first straight line forming an angle of θ_{X} therebetween,
a fourth straight line connecting the center of the driven gear and the index on the driven gear and the third straight line forming an angle of θ_{B} therebetween.

11. The photosensitive-member driving mechanism according to claim 8, wherein the driven gear comprises a first and second driven gears, and there is provided a transmission gear for transmitting the driving force from the first driven gear to the second driven gear.

12. The photosensitive-member driving mechanism according to claim 11, wherein the transmission gear is a gear having the same eccentricity characteristic as that of each driven gear.

13. The photosensitive-member driving mechanism according to claim 12, wherein the rotational phase of the transmission gear is set, such that indexes on the first driven gear and the transmission gear are coincident with the contact point between the first driven gear and the transmission gear, and indexes on the second driven gear and the transmission gear are coincident with the contact point between the second driven gear and the transmission gear.

14. The photosensitive-member driving mechanism according to claim 9, wherein θ_{X}=60° and θ_{B}−(θ_{A}−θ_{X})=−60° or θ_{X}==−60° and θ_{B}−(θ_{A}−θ_{X})=60° (the characters of “+” and “−” indicate a direction of rotation of the driven gear and the opposite direction of rotation of the driven gear, respectively), when the driven gear and the phase control gear are eccentric gears, and the driven gear and the phase control gear are provided with indexes indicative of the same rotational phase of both the gears,
a first straight line connecting the center of the driving gear and the center of the phase control gear and a second straight line connecting the center of the phase control gear and the index on the phase control gear forming an angle of θ_{A} therebetween,
a third straight line connecting the center of the phase control gear and the center of the driven gear and the first straight line forming an angle of θ_{X} therebetween,
a fourth straight line connecting the center of the driven gear and the index on the driven gear and the third straight line forming an angle of θ_{B} therebetween.

15. The photosensitive-member driving mechanism according to claim 9, wherein the driven gear comprises a first and second driven gears, and there is provided a transmission gear for transmitting the driving force from the first driven gear to the second driven gear.

16. The photosensitive-member driving mechanism according to claim 15, wherein the transmission gear is a gear having the same eccentricity characteristic as that of each driven gear.

17. The photosensitive-member driving mechanism according to claim 16, wherein the rotational phase of the transmission gear is set, such that indexes on the first driven gear and the transmission gear are coincident with the contact point between the first driven gear and the transmission gear, and indexes on the second driven gear and the transmission gear are coincident with the contact point between the second driven gear and the transmission gear.
